(19) United States
(12) Patent Application Publication
(10) Pub. No.: US 2013/0071680 A1
(43) Pub. Date: Mar. 21, 2013

(54) COATED ARTICLE AND METHOD FOR MAKING SAME

(71) Applicants: XIANG-HUA LV, Shenzhen City (CN); HE-XIAN LIN, Shenzhen City (CN); WEI-REN HE, Shenzhen City (CN); SHI-JIE YAN, Shenzhen City (CN)

(72) Inventors: XIANG-HUA LV, Shenzhen City (CN); HE-XIAN LIN, Shenzhen City (CN); WEI-REN HE, Shenzhen City (CN); SHI-JIE YAN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/441,300

(22) Filed: Apr. 6, 2012

(30) Foreign Application Priority Data
Sep. 21, 2011 (CN) 201110281711.7

(51) Int. Cl. B32B 15/02; C23C 28/02; B32B 15/04; B82Y 30/00

(52) U.S. Cl. 428/553; 428/656; 205/192; 205/184; 977/773

(57) ABSTRACT

A coated article includes a substrate, a Ni layer formed on the substrate, and a vacuum coated layer formed on the Ni layer. The vacuum coated layer is made of material selected from a group consisting of Al, Ti, Cr and Zn. A method for manufacturing an article is also provided.

### BACKGROUND

1. Technical Field

The exemplary disclosure generally relates to a coated article and a method for manufacturing the coated article.

2. Description of Related Art

Electroplating can be used to deposit chromium layer and nickel (Ni) layer on plastic housings of portable electronic devices to enhance abrasion and scratch resistance of the housings. However, Ni ions can sometimes escape the Ni layer and after getting on the users skin, cause itching.

Therefore, there is room for improvement within the art.

### BRIEF DESCRIPTION OF THE DRAWINGS

Many aspects of the embodiments may be better understood with reference to the following drawings. The components in the drawings are not necessarily drawn to scale, the emphasis instead being placed upon clearly illustrating the principles of the exemplary disclosure. Moreover, in the drawings like reference numerals designate corresponding parts throughout the several views. Wherever possible, the same reference numbers are used throughout the drawings to refer to the same or like elements of an embodiment.

FIG. 1 is a cross-sectional view of an exemplary embodiment of a coated article.

FIG. 2 is a schematic view of a vacuum sputtering device for manufacturing the coated article shown in FIG. 1.

### DETAILED DESCRIPTION

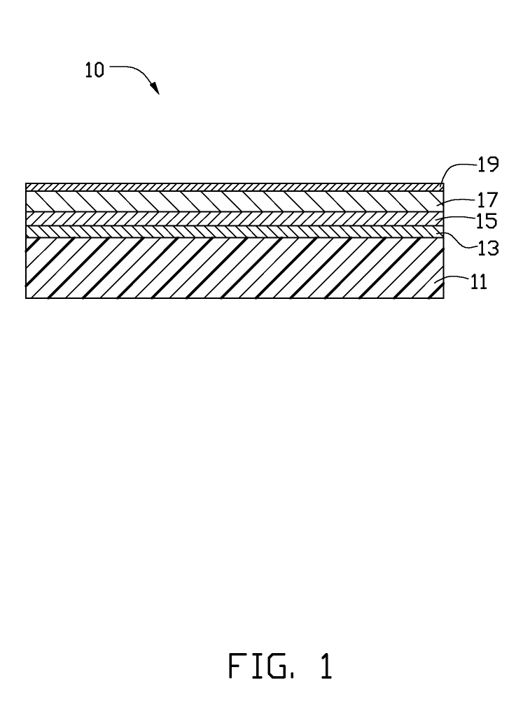

FIG. 1 shows an exemplary embodiment of a coated article 10. The coated article 10 includes a substrate 11, an electroless plating layer 13, a Cu layer 15, a Ni layer 17, and a vacuum coated layer 19 formed on the substrate 11, and in that order. The coated article 10 may be a housing of a mobile phone, a personal digital assistant (PDA), a notebook computer, a portable music player, a GPS navigator, or a digital camera.

The substrate 11 may be made of plastic selected from a group consisting of acrylonitrile-butadiene-styrene (ABS), polycarbonate (PC), polyamide (PA), polyphenylene sulfide (PPS), polypropylene (PP), and modified materials of above plastics.

The electroless plating layer 13 can be a Cu layer or a Ni layer formed by electroless plating. The electroless plating layer 13 has a thickness of about 2 μm to about 5 μm. The electroless plating layer 13 metallizes the surface of the substrate 11.

The Cu layer 15 is an electroplating layer. The Cu layer 15 has a thickness of about 6 μm to about 9 μm. The Cu layer 15 enhances the electrical conductivity of the substrate 11, and allows the Ni layer 17 formed on the Cu layer 15 to be smoother.

The Ni layer 17 is an electroplating layer. The Ni layer 17 has a thickness of about 30 μm to about 50 μm. The Ni layer 17 mainly consists of nanoparticles having a diameter in a range of about 10 nm to about 100 nm.

The vacuum coated layer 19 may be made of material selected from a group consisting of Al, Ti, Cr and Zn. The vacuum coated layer 19 has a thickness of about 3 μm to about 4 μm. The vacuum coated layer 19 prevents the Ni of the Ni layer 17 from releasing.

A method for manufacturing the coated article 10 may include the following steps:

The substrate 11 is provided. The substrate 11 may be made of plastic selected from a group consisting of ABS, PC, PA, PPS, PP, and modified materials of above plastics.

The substrate 11 may be pretreated. The pretreatment includes degreasing and roughening the substrate 11. The degreasing may be carried out by cleaning the substrate 10 using acetone for about 5 minutes and then ultrasonically cleaning the substrate 10 with ethanol for about 30 minutes. The roughening may be carried out by immersing the substrate 10 in a water solution contains 240 g/L-280 g/L roughening agent (PM847, bought from Rohm and Haas Company of U.S.A) and 720 g/L-760 g/L ethylene alcohol at a temperature from about 55 ° C. to about 60 ° C. for 15 minutes to 25 minutes.

The substrate 11 is treated with sensitizing process and activating process after the roughening process.

The electroless plating layer 13 is formed on the substrate 11 by electroless plating. The electroless plating layer 13 can be a Cu layer or a Ni layer. An electroless plating water solution used to form the electroless plating layer 13 mainly consists of metallic salt and reducing agent. The metallic salt is Cu salt or Ni salt. In the embodiment, the metallic salt is Cu sulfate or Ni sulfate, the reducing agent is sodium phosphite. The substrate 11 is immersed in the electroless plating water solution containing 20 g/L-24 g/L Cu sulfate or Ni sulfate, and 28 g/L-32 g/L sodium phosphite at a temperature from about 45° C. to about 50° C. for 28 minutes to 32 minutes. The pH value of the electroless plating water solution is about 9.0 to about 9.4.

The Cu layer 15 is formed on the electroless plating layer 13 by electroplating. An electroplating water solution is provided. The electroplating water solution mainly consists of blue vitriol (pentahydrate), sulfuric acid, chloride ion, and leveling agent. In the embodiment, the substrate 11 is immersed in an electroplating water solution includes 60 g/L-90 g/L blue vitriol, 180 g/L-220 g/L sulfuric acid, 0.05 mol/L-1.5 mol/L chloride ion, and 3 mol/L-8 mol/L leveling agent (PCM, bought from Rohm and Haas Company of U.S.A) at a temperature from about 20° C. to about 40° C. for 10 minutes to 15 minutes. The current density in the electroplating water solution is about 0.4 A/dm²-1.5 A/dm². The thickness of the Cu layer 15 is about 6 μm to about 9 μm.

The Ni layer 17 is formed on the Cu layer 15 by electroplating. An electroplating water solution used to form the Ni layer 17 mainly consists of Ni sulfate, Ni chloride and boric acid. In the embodiment, the substrate 11 is immersed in an electroplating water solution includes 260 g/L-300 g/L Ni sulfate, 40 g/L-50 g/L Ni chloride, and 40 g/L-50 g/L boric acid at a temperature from about 10° C. to about 50° C. The current density in the electroplating water solution is about 0.2 A/dm²-4 A/dm². The thickness of the Ni layer 17 is about 30 μm to about 50 μm.

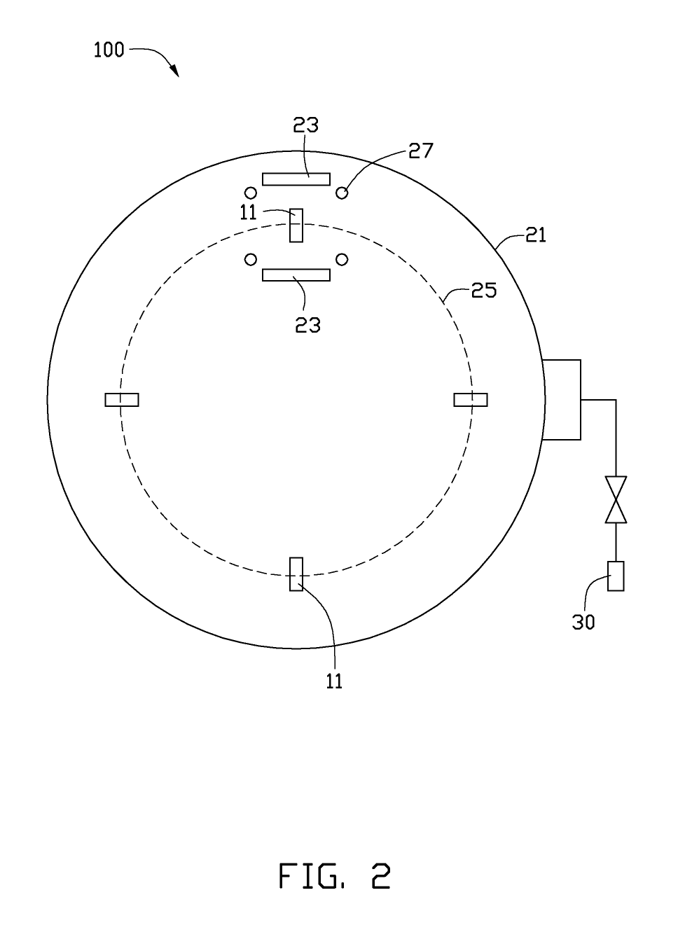

Referring to FIG. 2, a vacuum sputtering device 100 is provided. The vacuum sputtering device 100 includes a chamber 21 and a vacuum pump 30 connected to the chamber 21. The vacuum pump 30 is used to evacuate the chamber 21. The vacuum sputtering device 100 further includes two targets 23, a rotating bracket 25, and a plurality of gas inlets 27. The rotating bracket 25 rotates the substrate 11 in the chamber 21 relative to the targets 23. The two targets 23 face to each other, and are located on opposite sides of the rotating bracket 25. In the exemplary embodiment, the targets 23 are made of material selected from a group consisting of Al, Ti, Cr and Zn.

The vacuum coated layer 19 is formed on the Ni layer 17. The vacuum coated layer 19 may be made of material selected from a group consisting of Al, Ti, Cr and Zn. The substrate 11 is mounted on the rotating bracket 25 in the chamber 21. The chamber 21 is evacuated to about 6.0*10⁻³Pa to about 8.0*10⁻³ Pa by the vacuum pump 30. Argon gas is fed into the chamber 21 at a flux rate of about 150 Standard Cubic Centimeters per Minute (sccm) to about 200 sccm from the gas inlets 27. The targets 23 in the chamber 21 are applied a power between about 12 kW and about 15 kW. A bias voltage may be applied to the substrate 11 may be between about −100 volts (V) and about −150 V, for between about 60 minutes and about 120 minutes, to deposit the vacuum coated layer 19 on the Ni layer 17.

It is to be understood that the substrate 11 can also be made of metal, such as Al, Al alloy, Mg or Mg alloy. When the substrate 11 is made of metal, the electroless plating layer 13 and the Cu layer 15 may be omitted.

The vacuum coated layer 19 has excellent compactness that can prevent the Ni of the Ni layer 17 from releasing. Additionally, the Ni layer 17 mainly consists of nanoparticles having a diameter in a range of about 10 nm to about 100 nm, which improves the hardness of the nickel layer 17 as well as the coated article 10.

### EXAMPLE

The substrate 11 was made of PC and glass fibre (GF), the mass percentage of the GF is about 30%.

The substrate 11 was pretreated by degreasing, roughening, sensitizing, and activating process, and in that order. The roughening process was carried out by immersing the substrate 10 in a water solution including 260 g/L roughening agent and 740 g/L ethylene alcohol at a temperature about 55° C. for 20 minutes.

Depositing an electroless plating layer 13 on the substrate 11: the substrate 11 was immersed in an electroless plating water solution including 22 g/L Ni sulfate, and 32 g/L sodium phosphite at a temperature of 50° C. for 30 minutes. The pH value of the electroless plating water solution was about 9.2. The electroless plating layer 13 was a Ni layer.

Depositing a Cu layer 15 on the electroless plating layer 13: the substrate 11 was immersed in an electroplating water solution including 80 g/L blue vitriol, 220 g/L sulfuric acid, 0.07 mol/L chloride ion, and 4 mol/L leveling agent at a temperature about 28° C. for 8 minutes. The current density in the electroplating water solution was about 1.5 A/dm².

Electroplating to form a Ni layer 17 on the Cu layer 15: the electroplating water solution included 280 g/L Ni sulfate, 45 g/L Ni chloride, and 45 g/L boric acid. The temperature of the electroplating water solution was about 45° C. The current density in the electroplating water solution was about 4 A/dm².

Sputtering to form a vacuum coated layer 19 on the Ni layer 19: the targets 23 are Cr targets, the flux rate of argon was about 180 sccm, a power of about 10 kW was applied to the targets 23; the inside temperature of the chamber 21 was 40° C.; a bias voltage of 100 V is applied to the substrate 11; sputtering of the vacuum coated layer 19 takes 80 min.

The coated article 10 was tested by the European nickel release standard EN1811 which stipulates a release rate of less than 0.5 μg/cm²/week. The coated article 10 had a release rate of only 0.1978 μg/cm²/week.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

1. A coated article, comprising:
a substrate;
a Ni layer formed on the substrate, the Ni layer being an electroplating layer, the Ni layer consisting of Ni element, the Ni layer mainly comprising nanoparticles having a diameter in a range of about 10 nm to about 100 nm; and
a vacuum coated layer formed on the Ni layer, the vacuum coated layer being made of material selected from a group consisting of Al, Ti, Cr and Zn.

2. The coated article as claimed in claim 1, wherein the vacuum coated layer has a thickness of about 3 μm to about 4 μm.

3. (canceled)

4. The coated article as claimed in claim 1, wherein the Ni layer has a thickness of about 30 μm to about 50 μm.

5. (canceled)

6. The coated article as claimed in claim 1, wherein the coated article further comprises a Cu layer formed between the substrate and the Ni layer, the Cu layer is an electroplating layer.

7. The coated article as claimed in claim 6, wherein the Cu layer has a thickness of about 6 μm to about 9 μm.

8. The coated article as claimed in claim 6, further comprising an electroless plating layer formed between the substrate and the Cu layer.

9. The coated article as claimed in claim 8, wherein the electroless plating layer is a Cu layer or a Ni layer and has a thickness of about 2 μm to about 5 μm.

10. A method for manufacturing a coated article, comprising:
providing a substrate;
electroplating to form a Ni layer on the substrate; and
sputtering depositing a vacuum coated layer on the Ni layer, the targets used to form the vacuum coated layer are made of material selected from a group consisting of Al, Ti, Cr and Zn; the vacuum coated layer being made of material selected from a group consisting of Al, Ti, Cr and Zn.

11. The method of claim 10, wherein during forming the Ni layer, the substrate is immersed in an electroplating water solution comprises 260 g/L-300 g/L nickel sulfate, 40 g/L-50 g/L nickel chloride, and 40 g/L-50 g/L boric acid at a temperature from about 10° C. to about 50° C., the current density in the electroplating water solution is about 0.2 A/dm²-4 A/dm².

12. The method of claim 10, wherein the method further comprise a step of forming a Cu layer on the substrate before electroplating the Ni layer.

13. The method of claim 12, wherein during forming the Cu layer, the substrate is immersed in an electroplating water solution comprises 60 g/L-90 g/L blue vitriol, 180 g/L-220 g/L sulfuric acid, 0.05 mol/L -1.5 mol/L chloride ion, and 3 mol/L-8 mol/L leveling agent at a temperature from about 20° C. to about 40° C. for 10 minutes to 15 minutes, the current density during the electroplating water solution is about 0.4 A/dm²-1.5 A/dm².

14. The method of claim 12, wherein the method further comprise a step of forming a electroless plating layer on the substrate before electroplating the Cu layer.

15. The method of claim 14, wherein during forming the electroless plating layer, the substrate is immersed in an electroless plating water solution comprises 20 g/L-24 g/L copper sulfate or nickel sulfate, and 28 g/L-32 g/L sodium phosphite at a temperature from about 45° C. to about 50° C. for 28 minutes to 32 minutes, the pH value of the electroless plating solution is about 9.0 to about 9.4.

16. The method of claim 14, wherein the method further comprise a step of pretreating the substrate before forming the electroless plating layer, the pretreatment comprise degreasing and roughening.

17. The method of claim 16, wherein the roughening is carried out by immersing the substrate in a water solution comprises 240-280 g/L roughening agent and 720 g/L-760 g/L ethylene alcohol at a temperature from about 55° C. to about 60° C. for 15 minutes to 25 minutes.
